(19) United States
(12) Patent Application Publication
(10) Pub. No.: US 2022/0216519 A1
(43) Pub. Date: Jul. 7, 2022

(54) Lithium ion batteries

(71) Applicant: Wacker Chemie AG, Munich (DE)

(72) Inventors: Irmgard Buchberger, München (DE); Stefan Haufe, Neubiberg (DE); Dominik Jantke, Burghausen (DE)

(73) Assignee: Wacker Chemie AG, Munich (DE)

(21) Appl. No.: 17/604,435

(22) PCT Filed: Apr. 17, 2019
(86) PCT No.: PCT/EP2019/059977

§ 371 Date: Oct. 17, 2021

(51) Int. Cl. H01M 10/0568; H01M 4/134; H01M 10/0525; H01M 50/124; H01M 4/38; H01M 4/62

(52) U.S. Cl. CPC H01M 10/0568; H01M 4/134; H01M 10/0525; H01M 2004/027; H01M 4/386; H01M 4/62; H01M 50/1243

(57) ABSTRACT

A lithium ion battery and process for producing the same. The lithium ion batteries include a cathode, an anode, a separator, an electrolyte and a battery housing which receives these components. The cathode, the anode, the separator or any other reservoir located in the battery housing and differing from the electrolyte contains one or more organic or inorganic nitrates or one or more organic or inorganic nitrites and the anode contains silicon particles with a silicon content of ≥90 wt. % in relation to the total weight of the silicon particles.

The invention relates to lithium ion batteries containing an anode containing silicon particles and also organic or inorganic nitrates or nitrites and also a process for producing the lithium ion batteries.

Rechargeable lithium ion batteries are at present the most practically useful electrochemical energy stores having the highest gravimetric energy densities of, for example, up to 250 Wh/kg. Graphitic carbon is widespread as active material for the negative electrode (“anode”). However, the electrochemical capacity of graphite is theoretically at most 372 mAh/g. Silicon is recommended as active anode material having a higher electrochemical capacity. Silicon disadvantageously experiences a volume change of up to 300% on incorporation and release of lithium. As a result, the silicon particles are subjected to high mechanical stresses, which can ultimately lead to them breaking apart. This process is also referred to as electrochemical milling and leads to a loss of electrical contacting of the active material in the electrode and thus to a loss of capacity of the electrode. The decrease in capacity over the course of a number of charging and discharging cycles is also referred to as continuous capacity loss or fading and is generally irreversible. A further problem is the reactivity of silicon toward constituents of the electrolyte. As a result of this, passivating protective layers (solid electrolyte interface; SEI) are formed on the silicon surface, which leads to immobilization of lithium and thus to a limitation of the capacity of the battery. Such an SEI is formed firstly on first-time charging of silicon-containing lithium ion batteries, which causes initial capacity losses. During further operation of the lithium ion batteries, volume changes of the silicon particles occur on each charging and discharging cycle, as a result of which fresh silicon surfaces are exposed and these in turn react with constituents of the electrolyte and form further SEIs. This, too, leads to immobilization of lithium and thus to a continuous, irreversible loss of capacity.

Lithium ion batteries frequently contain cyclic/aliphatic carbonates, for example the methyl or ethyl carbonates mentioned in U.S. Pat. No. 7,476,469, as main component in the electrolyte. In the case of graphite anodes, film-forming additives such as vinylene carbonate (VC) are typically added to the electrolyte in order to increase the power of the cells. In the case of silicon-containing anodes, fluoroethylene carbonate (FEC) is often added to the electrolyte in order to stabilize the SEI against volume changes in the silicon active material during charging and discharging of the lithium ion battery. US2017033404, US20180062201, WO2017/EP080808 (application number) or WO 2018/065046 also teach the use of electrolyte additives such as nitrates. DE 102013210631 teaches adding fluorene-containing cyclic carbonates in addition to lithium nitrate to the electrolyte.

US2014170478 and JP2005197175 are concerned with batteries which contain lithium metal as anode. In order to suppress the formation of lithium dendrites on the surface of the lithium metal, nitrogen-containing compounds such as inorganic nitrate salts are added to the battery. The anodes of US2014170478 and JP2005197175, however, do not contain any silicon particles. Lithium metal anodes and anodes containing silicon particles are associated technologically with completely different problems. US2002094480 recommends nitrite as additive for anodes containing alkali metal (alloys).

US2006222944 describes lithium ion batteries having silicon (alloys) as active anode material which is applied as thin film directly to the power outlet lead and for this purpose recommends the addition of various additives such as nitrates. However, the active anode material of US2006222944 has only considerably limited contact with the electrolyte, so that such approaches are not comparable to anode coatings in which silicon particles are embedded. WO17047030 describes introduction of lithium nitrate into the cell by means of electrolysis of a nitrate-containing electrolyte. The negative electrodes of WO17047030 contain lithium-containing silicon compounds with SiOx (0.5≤x≤1.6).

In the light of this background, it is an object of the present invention to provide lithium ion batteries having anodes containing silicon particles, which batteries have a high initial reversible capacity and a stable electrochemical behavior with a very small decrease in the reversible capacity (fading) in subsequent cycles.

The invention provides lithium ion batteries comprising cathode, anode, separator and electrolyte and a battery housing accommodating the abovementioned components, characterized in that a cathode, an anode, a separator or another reservoir which is different from the electrolyte and is present in the battery housing contains one or more organic or inorganic nitrates or one or more organic or inorganic nitrites and the anode contains silicon particles having a silicon content of ≥90% by weight, based on the total weight of the silicon particles.

The invention further provides a process for producing lithium ion batteries comprising cathode, anode, separator and electrolyte and a battery housing accommodating the abovementioned components, characterized in that one or more organic or inorganic nitrates or one or more organic or inorganic nitrites are introduced into a cathode, into an anode, into a separator or into another reservoir which is different from the electrolyte and is present in the battery housing and silicon particles having a silicon content of ≥90% by weight, based on the total weight of the silicon particles, are used for producing the anode.

The other reservoir which is different from the electrolyte and is present in the battery housing will hereinafter also be referred to as other reservoir for short. The silicon particles having a silicon content of ≥90% by weight will hereinafter also be referred to as silicon particles for short. The organic or inorganic nitrates or organic or inorganic nitrites will hereinafter also be referred to as R/M-NOₓ compounds for short.

The organic nitrates and/or the organic nitrites can, for example, be present as esters of nitric acid or as esters of nitrous acid. Such esters are generally esters of nitric acid or of nitrous acid with aromatic or in particular aliphatic, optionally substituted or unsubstituted, alcohols which preferably have from 1 to 20 carbon atoms, particularly preferably from 1 to 10 carbon atoms and most preferably from 1 to 5 carbon atoms. Examples of substituents are halogen, hydroxy, alkoxy, aryloxy, carboxy or optionally substituted amine groups. Preferred esters of nitric acid are propyl nitrate and butyl nitrate, in particular isopropyl nitrate and isobutyl nitrate. Preferred esters of nitrous acid are methyl nitrite, ethyl nitrite, propyl nitrite and butyl nitrite, in particular isopropyl nitrite, isobutyl nitrite, t-butyl nitrite, benzyl nitrite and phenyl nitrite. Particular preference is given to esters of nitrous acid.

Preferred R/M-NOₓ compounds are inorganic nitrites and in particular inorganic nitrates. The inorganic nitrates and/or inorganic nitrites are preferably present in the form of their salts, particularly preferably in the form of their alkaline earth/alkaline metal or ammonium salts and most preferably in the form of their alkali metal salts. Ammonium salts of this type contain, for example, tetraalkylammonium or tetraarylammonium compounds whose alkyl or aryl radicals can optionally be substituted or unsubstituted and preferably have from 1 to 20 carbon atoms, particularly preferably from 1 to 10 carbon atoms and most preferably from 1 to 5 carbon atoms. Examples of substituents are halogen, hydroxy, alkoxy, aryloxy or optionally substituted amine groups. Examples of such salts are tetrabutylammonium, tetraethylammonium or tetrapropylammonium salts of nitrate or nitrite. Preferred alkali metal salts are sodium nitrite, potassium nitrite and in particular lithium nitrite. Particularly preferred alkali metal salts are sodium nitrate, potassium nitrate and lithium nitrate. The most preferred R/M-NOₓ compound is lithium nitrate.

The anode, the cathode and/or the separator preferably contain from 0.01 to 5.0 mg/cm², particularly preferably from 0.02 to 2.0 mg/cm² and most preferably from 0.1 to 1.5 mg/cm², of R/M-NOₓ compounds, in each case based on the area of the anode, of the cathode and/or of the separator.

The anode, the cathode and/or the separator preferably contain from 0.14 to 73.0 μmol/cm², particularly preferably from 0.29 to 29.0 μmol/cm² and most preferably from 1.45 to 21.75 μmol/cm², of R/M-NOₓ compounds, in each case based on the area of the anode, of the cathode and/or of the separator.

The anode, the cathode and the separator in total preferably contain from 0.5 to 60% by weight, particularly preferably from 1 to 40% by weight and most preferably from 4 to 20% by weight, of R/M-NOₓ compounds, based on the total dry weight of the anode coating, of the cathode, and of the separator.

The anode, the cathode or the separator preferably contain from 0.5 to 60% by weight, particularly preferably from 1 to 40% by weight and most preferably from 4 to 20% by weight, of R/M-NOₓ compounds. These figures are based in the case of the anode on the dry weight of the anode coating, in the case of the cathode on the dry weight of the cathode coating and in the case of the separator on the dry weight of the separator.

The cathode, the anode and/or the separator contain R/M-NOₓ compounds in an amount which preferably corresponds to from 0.01 to 10% by weight, particularly preferably from 0.05 to 5.0% by weight and most preferably from 0.1 to 2.5% by weight, based on the weight of the electrolyte.

The R/M-NOₓ compounds are generally sparingly soluble in the electrolyte. The solubility of the R/M-NOₓ compounds in the electrolyte under standard conditions in accordance with DIN 50014 (23/50) is preferably <2% by weight, particularly preferably ≤1% by weight and most preferably ≤0.5% by weight.

The R/M-NOₓ compounds can be applied in the form of a film or in the form of a coating to the cathode, the anode and/or the separator. As an alternative, the R/M-NOₓ compounds can also be a constituent of the cathode coating or anode coating or have been introduced into the separator.

The R/M-NOₓ compounds can be introduced into the cathode, into the anode or into the separator by, for example, one or more solutions containing R/M-NOₓ compounds being applied to the cathode, the anode or the separator and subsequently being dried. Application can, for example, be carried out by spraying methods or by impregnation or by dripping-on. As an alternative, the cathode, the anode or the separator can be dipped into appropriate solutions. For this purpose, it is possible to use the customary apparatuses and procedures.

The application of the R/M-NOₓ compounds is carried out at temperatures of preferably from 10 to 120° C., particularly preferably from 15 to 80° C. and most preferably from 20 to 30° C. Here, the solutions of the R/M-NOₓ compounds, the anodes, the cathodes and/or the separators can have the abovementioned temperatures.

The solutions of the R/M-NOₓ compounds can contain one or more solvents. Examples of solvents are water or organic solvents such as alcohols, ethers or esters, in particular ethanol, tetrahydrofuran, glyme, dimethyl ether or 1,3-dioxalane. Preference is given to solvent mixtures containing water and one or more organic solvents, in particular alcohols. Such solvent mixtures preferably contain ≥50% by weight and particularly preferably ≥80% by weight of water, based on the total weight of the solvent mixture. Preference is also given to using water or alcohols as exclusive solvent. These solutions preferably contain R/M-NOₓ compounds in an amount of from 1 to 700 mg, in particular from 10 to 500 mg, per milliliter of solvent. The solvent is preferably selected so that the R/M-NOₓ compounds are completely dissolved in the solvent.

After application of solutions containing R/M-NOₓ compounds to the cathode, the anode or the separator, drying can be carried out, for example, at temperatures of from 30 to 120° C., in particular from 50 to 120° C. Drying can optionally be carried out under reduced pressure. The term reduced pressure is generally used to refer to a pressure lower than ambient pressure. Continuous or batch processes are generally suitable for drying. Drying can, for example, be carried out over a period of from 1 minute to 24 hours, preferably from 1 minute to 12 hours and more preferably from 1 minute to 1 hour.

In an alternative procedure, the R/M-NOₓ compounds can also be used as additional components in the production of the anodes, cathodes or separators, i.e., for example, as constituent of the anode coating composition, cathode coating composition or separator formulation for producing the anodes, cathodes or separators.

The other reservoir can, for example have been applied to the inside, in particular directly to the inside, of the battery housing. The inside is the side of the battery housing which is oriented toward the cathode, anode and the separator of the lithium ion battery.

The other reservoir contains R/M-NOₓ compounds in an amount which preferably corresponds to from 0.01 to 10% by weight, particularly preferably from 0.02 to 5% by weight and most preferably from 0.05 to 2.5% by weight, based on the total weight of the electrolyte.

For example, the inside of the battery housing can bear a coating containing R/M-NOₓ compounds. The coating can be based on, for example, one or more R/M-NOₓ compounds and optionally one or more further constituents such as adhesion promoters or in particular polymers. Preference is given to the polymers which are mentioned further below as binders for the anode materials or for the cathode materials. Particular preference is given to polymethyl (meth)acrylate, poly(meth)acrylic acid (salts) or styrene-butadiene copolymers. As adhesion promoter, it is possible to use, for example, silanes.

A coating preferably contains from 0 to 60% by weight, in particular from 1 to 50% by weight, of further constituents, in particular polymers. A coating preferably contains form 40 to 100% by weight, in particular from 50 to 99% by weight, of R/M-NOₓ compounds. The figures in % by weight are in each case based on the dry weight of the coating.

The coating has a layer thickness of preferably from 0.5 to 5 μm, particularly preferably from 0.5 to 3 μm and most preferably from 0.5 to 2 μm.

The coating is obtainable by, for example, a solution containing R/M-NOₓ compounds being applied directly to the inside of the battery housing or to a polymer-coated inside of the battery housing. The solutions preferably contain the further constituents, in particular the polymers, in a concentration of preferably from 0.1 to 20% by weight, based on the total weight of the solvents. The application of the solutions can, for example, be carried out by means of spraying-on, impregnation or dipping. Furthermore, coating can be carried out as described further above for the cathode, the anode or the separator, in particular in respect of solvents, temperatures or drying.

As an alternative or in addition, an other reservoir can be a porous support, for example in the form of pads, fibers, textile structures, films or sheets, which contains R/M-NOₓ compounds and optionally one or more further constituents such as adhesion promoters or in particular polymers. Textile structures can be woven or nonwoven. The porous support can, for example, be based on materials which are also customary for separators. Examples of materials for the porous support are glass fibers, polyesters, Teflon, polyethylenes, polypropylenes or polytetrafluoroethylene (PTFE).

The porous support can, for example, line the inside of the battery housing or have been introduced as additional winding around the cell stack or as additional chamber, in particular in the case of a laminated thin-film housing, into the lithium ion battery.

The R/M-NOₓ compounds can be applied to the porous support by means of, for example, spraying-on, impregnation or dipping. Here, it is possible, for example, to follow a procedure as described further above for the cathode, the anode or the separator.

The porous support contains R/M-NOₓ compounds in an amount of preferably from 0.01 to 5.0 mg/cm², particularly preferably from 0.02 to 2.0 mg/cm² and most preferably from 0.05 to 1.5 mg/cm², based on the area of the porous support.

The porous support contains R/M-NOₓ compounds in an amount of preferably from 0.14 to 73.0 μmol/cm², particularly preferably from 0.29 to 29.0 μmol/cm² and most preferably from 0.72 to 21.75 μmol/cm², based on the area of the porous support.

The other reservoir is generally in contact with the electrolyte, like the anode, the cathode or the separator in conventional batteries.

The anode material contains silicon particles.

The volume-weighted particle size distribution on the silicon particles is preferably between the diameter percentiles d₁₀≥0.2 μm and d₉₀≤20.0 μm, particularly preferably between d₁₀≥0.2 μm and d₉₀≤10.0 μm and most preferably between d₁₀≥0.2 μm to d₉₀≤5.0 μm.

The silicon particles have a volume-weighted particle size distribution having a diameter percentile d₁₀ of preferably ≤10 μm, particularly preferably ≤5 μm, even more preferably ≤3 μm and most preferably ≤1 μm. The silicon particles have a volume-weighted particle size distribution having a diameter percentile d₉₀ of preferably ≥0.5 μm. In one embodiment of the present invention, the abovementioned d₉₀ value is preferably ≥5 μm.

The volume-weighted particle size distribution of the silicon particles has a width d₉₀-d₁₀ of preferably ≤15.0 μm, more preferably ≤12.0 μm, even more preferably ≤10.0 μm, particularly preferably ≤8.0 μm and most preferably ≤4.0 μm. The volume-weighted particle size distribution of the silicon particles has a width d₉₀-d₁₀ of preferably ≥0.6 μm, particularly preferably ≥0.8 μm and most preferably ≥1.0 μm.

The volume-weighted particle size distribution of the silicon particles has a diameter percentile d₅₀ of preferably from 0.5 to 10.0 μm, particularly preferably from 0.6 to 7.0 μm, even more preferably 2.0 to 6.0 μm and most preferably from 0.7 to 3.0 μm. As an alternative, preference is also given to silicon particles whose volume-weighted particle size distribution has a diameter percentile d₅₀ of from 10 to 500 nm, particularly preferably from 20 to 300 nm, even more preferably from 30 to 200 nm and most preferably from 40 to 100 nm.

The volume-weighted particle size distribution of the silicon particles can be determined by static laser light scattering using the Mie model by means of the measuring instrument Horiba LA 950 using ethanol as dispersion medium for the silicon particles.

The silicon particles are preferably not aggregated, preferably not agglomerated and/or preferably not nanostructured. Aggregated means that a plurality of spherical or largely spherical primary particles as are, for example, initially formed in the production of silicon particles by means of gas-phase processes grow together, fuse together or sinter together to form aggregates. Aggregates are thus a particle comprising a plurality of primary particles. Aggregates can form agglomerates. Agglomerates are a loose assembly of aggregates. Agglomerates can typically be easily broken up again into aggregates by kneading or dispersion processes. Aggregates cannot be completely broken up into the primary particles by means of such processes. Aggregates and agglomerates inevitably have, owing to their formation, very different sphericities and particle shapes than the silicon particles according to the invention. The presence of silicon particles in the form of aggregates or agglomerates can, for example, be made visible by means of conventional scanning electron microscopy (SEM). On the other hand, static light scattering methods for determining the particle size distributions or particle diameters of silicon particles cannot distinguish between aggregates or agglomerates.

Silicon particles which are not nanostructured generally have characteristic BET surface areas. The BET surface areas of the silicon particles are preferably from 0.01 to 30.0 m²/g, more preferably from 0.1 to 25.0 m²/g, particularly preferably from 0.2 to 20.0 m²/g and most preferably from 0.2 to 18.0 m²/g. The BET surface area is determined in accordance with DIN 66131 (using nitrogen).

The silicon particles have a sphericity of preferably 0.3≤ψ≤0.9, particularly preferably 0.5≤ψ≤0.85 and most preferably 0.65≤ψ≤0.85. Silicon particles having such sphericities are obtainable, in particular, by production by means of milling processes. The sphericity w is the ratio of the surface area of a sphere of the same volume to the actual surface are of a body (definition of Wadell). Sphericities can, for example, be determined from conventional SEM images.

The silicon particles have a silicon content of preferably ≥95% by weight, particularly preferably 98% by weight and more preferably 99% by weight, based on the total weight of the silicon particles.

Preference is given to polycrystalline silicon particles. The silicon particles are preferably based on elemental silicon. The elemental silicon can be high-purity silicon or silicon from metallurgical processing which can, for example, contain elemental impurities such as Fe, Al, Ca, Cu, Zr, C. The silicon particles can optionally be doped with foreign atoms (for example B, P, As). Such foreign atoms are generally present only in a small proportion.

The silicon particles can contain silicon oxide, in particular on the surface of the silicon particles. If the silicon particles contain a silicon oxide, then the stoichiometry of the oxide SiOₓ is preferably in the range 0<x<1.3. The layer thickness of silicon oxide on the surface of the silicon particles is preferably less than 10 nm. The silicon particles have an oxygen content of preferably ≤5% by weight, particularly preferably ≤3% by weight and most preferably ≤1% by weight, based on the total weight of the silicon particles.

The surface of the silicon particles can optionally be covered by an oxide layer or by other inorganic and organic groups. Particularly preferred silicon particles bear Si—OH or Si—H groups or covalently bound organic groups, for example alcohols or alkenes, on the surface.

The silicon particles are preferably not present in the form of alloys M_{y}Si. M can be, for example, a metal or semimetal, e.g. an alkali metal, Sn, Al, B Mg, Ca, Ag or Zn. The stoichiometry of alloys M_{y}Si is in the range of preferably y≤5 and particularly preferably y≤2. y=0 is most preferred.

The silicon particles can, for example, be produced by milling processes. Possible milling processes are, for example, dry milling or wet milling processes, as described, for example, in DE-A 102015215415.

The anode material generally comprises silicon particles, one or more binders, optionally organic or inorganic nitrates, optionally organic or inorganic nitrites, optionally graphite, optionally one or more further electrically conductive components and optionally one or more additives.

The proportion of silicon in the anode material is preferably from 40 to 95% by weight, particularly preferably from 50 to 90% by weight and most preferably from 60 to 80% by weight, based on the total weight of the anode material.

Preferred binders are polyacrylic acid or alkali metal salts thereof, in particular lithium or sodium salts, polyvinyl alcohols, cellulose or cellulose derivatives, polyvinylidene fluoride, polytetrafluorethylene, polyolefins, polyimides, in particular polyamidimides, or thermoplastic elastomers, in particular ethylene-propylene-diene terpolymers. Particular preference is given to polyacrylic acid, polymethacrylic acid or cellulose derivatives, in particular carboxymethyl cellulose. The alkali metal salts, in particular lithium or sodium salts, of the abovementioned binders are also particularly preferred. The alkali metals salts, in particular lithium or sodium salts, of polyacrylic acid or of polymethacrylic acid are most preferred. It is possible for all or preferably a proportion of the acid groups of a binder to be present in the form of salts. The binders have a molar mass of preferably from 100.000 to 1.000.000 g/mol. It is also possible to use mixtures of two or more binders.

As graphite, it is generally possible to use natural or synthetic graphite. The graphite particles preferably have a volume-weighted particle size distribution between the diameter percentiles d₁₀>0.2 μm and d₉₀<200 μm.

Preferred further electrically conductive components are conductive carbon black, carbon nanotubes or metallic particles, for example copper. Amorphous carbon, in particular hard carbon or soft carbon, is also preferred. Amorphous carbon is, as is known, not graphitic. The anode material preferably contains from 0 to 40% by weight, particularly preferably from 0 to 30% by weight and most preferably from 0 to 20% by weight, of further electrically conductive components, based on the total weight of the anode material.

Examples of anode material additives are pore formers, dispersants, levelling agents or dopants, for example elemental lithium.

Preferred formulations for the anode material of the lithium ion batteries preferably contain from 5 to 95% by weight, in particular from 60 to 85% by weight of silicon particles; from 0 to 40% by weight, in particular from 0 to 20% by weight, further electrically conductive components; from 0 to 80% by weight, in particular from 5 to 30% by weight, of graphite; from 0 to 25% by weight, in particular from 5 to 15% by weight, of binders; and optionally from 0 to 80% by weight, in particular from 0.1 to 5% by weight, of additives; where the figures in % by weight are based on the total weight of the anode material and the proportions of all constituents of the anode material add up to 100% by weight.

In a preferred formulation for the anode material, the total proportion of graphite particles and/or further electrically conductive components is at least 10% by weight, based on the total weight of the anode material.

The processing of the constituents of the anode material to give an anode ink or paste can, for example, be carried out in a solvent such as water, hexane, toluene, tetrahydrofuran, N-methylpyrrolidone, N-ethylpyrrolidone, acetone, ethyl acetate, dimethyl sulfoxide, dimethylacetamide or ethanol or solvent mixtures, preferably using rotor-stator machines, high-energy mills, planetary kneaders, stirred bore mills, shaking tables or ultrasonic instruments.

The anode ink or paste has a pH of preferably from 2 to 7.5 (determined at 20° C., for example using the pH meter WTW pH 340i with electrode SenTix RJD).

The anode ink or paste can, for example, be applied to a copper foil or another current collector, as described, for example, in WO 2015/117838.

The layer thickness, i.e. the dry layer thickness, of the anode coating is preferably from 2 μm to 500 μm, particularly preferably from 10 μm to 300 μm.

The cathode material preferably comprises active cathode materials, binders, optionally organic or inorganic nitrates, optionally organic or inorganic nitrates, optionally electrically conductive components and optionally additives. Preferred active cathode materials are lithium cobalt oxide, lithium nickel oxide, lithium nickel cobalt oxide (doped or undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate, lithium vanadium oxides or lithium nickel cobalt aluminum oxides.

As binders, electrically conductive components and additives, it is possible to use the appropriate components described further above for the anode material or the components described for this purpose in US2014/0170478. The production of the cathode can be carried out in a conventional way, for example as indicated in US2014/0170478 or by a method analogous to the above-described production of the anode.

The separator is generally based on an electrically insulating membrane which is permeable to ions, as is customary in battery production. The separator separates, as is known, the anode from the cathode and thus prevents electronically conductive connections between the electrodes (short circuit). The separator can, for example, be based on polyolefins such as polyethylenes or polypropylenes, silicones, glass fiber filter papers, ceramic materials such as silicon oxides, aluminum oxides or mixed oxides thereof or microporous xerogel layers such as microporous pseudoboehmite layers and optionally contain organic or inorganic nitrates or optionally organic or inorganic nitrites.

The electrolytes contain, for example, aprotic solvents, optionally lithium-containing electrolyte salts, optionally film formers and optionally additives.

Lithium-containing electrolyte salts are preferably selected from the group consisting of LiPF₆, LiBF₄, LiClO₄, LiAsF₆, (LiB(C₂O₄)₂, LiBF₂(C₂O₄)), LiC(SO₂CxF₂ₓ₊₁)₃, LiN(SO₂CₓF₂ₓ₊₁)₂ and LiSO₃CₓF₂ₓ₊, where x assumes integer values of from 0 to 8, and mixtures thereof.

The lithium-containing electrolyte salts are present in the electrolyte in an amount of preferably ≥1% by weight, particularly preferably from 1 to 20% by weight and most preferably from 10 to 15% by weight, based on the total weight of the electrolyte.

The aprotic solvent is preferably selected from the group consisting of organic carbonates such as dimethyl carbonate, diethyl carbonate, ethyl methyl carbonate, ethylene carbonate, vinylene carbonate, propylene carbonate, butylene carbonate; cyclic and linear esters such as methyl acetate, ethyl acetate, butyl acetate, propyl propionate, ethyl butyrate, ethyl isobutyrate; cyclic and linear ethers such 2-methyltetrahydrofuran, 1,2-diethoxymethane, THF, dioxane, 1,3-dioxolane, diisopropyl ether, diethylene glycol dimethyl ether; ketones such as cyclopentanone, diisopropyl ketone, methyl isobutyl ketone; lactones such as γ-butyrolactone; sulfolanes, dimethyl sulfoxide, formamide, dimethylformamide, 3-methyl-1,3-oxazolidine-2-one and mixtures of these solvents. Particular preference is given to the above-described organic carbonates.

Examples of film formers are vinylene carbonate, ethylene carbonate and in particular fluoroethylene carbonate. The electrolyte preferably contains up to 10% by weight, particularly preferably from 0.1 to 5% by weight and even more preferably from 0.5 to 3% by weight, of film formers, based on the total weight of the electrolyte. However, film formers can also be dispensed with in the electrolyte. The addition of film formers to the electrolyte enables the cyclic behavior of lithium ion batteries to be improved further.

Examples of electrolyte additives are organic isocyanates, for example to reduce the water content, HF scavengers, solubilizers for LiF, organic lithium salts, inorganic lithium salts, complex salts, amines such as tributylamine, tripentylamine, trihexylamine or triisooctylamine and/or nitriles such as capronitrile, valonitrile or 3-(fluorodimethylsilyl)butane nitrile.

The electrolyte which is introduced into the lithium ion battery preferably does not contain any organic or inorganic nitrates according to the invention and/or does not contain any organic or inorganic nitrites according to the invention.

The cathode, the anode, the separator, the electrolyte and further components, e.g. the battery housing, can be assembled in a conventional manner to give a lithium ion battery, as described, for example, in U.S. Pat. No. 9,831,527, US2011014518 or WO 2015/117838. Unless indicated otherwise, conventional starting materials and methods can be employed. The lithium ion batteries of the invention can be produced in all customary forms, for example in rolled, folded or stacked form.

The anode material, in particular the silicon particles, is preferably only partially lithiated in the fully charged lithium ion battery. Fully charged refers to the state of the battery in which the anode material of the battery has its highest loading with lithium. Partial lithiation of the anode material means that the maximum lithium uptake capability of the silicon particles in the anode material is not exhausted. The maximum lithium uptake capability of the silicon particles generally corresponds to the formula Li_{4.4}Si and is thus 4.4 lithium atoms per silicon atom. This corresponds to a maximum specific capacity of 4200 mAh per gram of silicon.

The ratio of the lithium atoms to the silicon atoms in the anode of a lithium ion battery (Li/Si ratio) can, for example, be set via the electric charge flow. The degree of lithiation of the anode material or of the silicon particles present in the anode material is proportional to the electric charge which has flowed. In this variant, the capacity of the anode material for lithium is not fully exploited when charging the lithium ion batteries. This results in partial lithiation of the anode.

In an alternative, preferred variant, the Li/Si ratio of a lithium ion battery is set by cell balancing. Here, the lithium ion batteries are configured so that the lithium uptake capability of the anode is preferably greater than the lithium release capability of the cathode. This leads to the lithium uptake capability of the anode not being fully exploited in the fully charged battery, i.e. the anode material is only partially lithiated.

In the partial lithiation according to the invention, the Li/Si ratio in the anode material in the fully charged state of the lithium ion battery is preferably ≤2.2, particularly preferably ≤1.98 and most preferably ≤1.76. The Li/Si ratio in the anode material in the fully charged state of the lithium ion battery is preferably ≥0.22, particularly preferably ≥0.44 and most preferably ≥0.66.

The capacity of the silicon of the anode material of the lithium ion battery is preferably utilized to an extent of ≤50%, particularly preferably ≤45% and most preferably ≤40%, based on a capacity of 4200 mAh per gram of silicon.

The degree of lithiation of silicon or the utilization of the capacity of silicon for lithium (Si capacity utilization a) can, for example, be determined as described in WO2017/025346 on page 11, line 4 to page 12, line 25.

The lithium ion batteries of the invention surprisingly display an improved cycling behavior. The lithium ion batteries have a small irreversible capacity loss in the first charging cycle and stable electrochemical behavior with only slight fading the subsequent cycles. The procedure according to the invention thus enables a low initial capacity loss and in particular a low continuous capacity loss of the lithium ion batteries to be achieved. Even after many cycles, lithium ion batteries according to the invention display virtually no fading phenomena, for example as a result of mechanical destruction of the anode material or SEI.

Addition of film formers to the electrolyte can improve the cycling behavior of lithium ion batteries further. Film formers and the use according to the invention of the nitrates or nitrites according to the invention act in a synergistic manner here.

The following examples serve to illustrate the invention.

### EXAMPLES 1a-d

Impregnation of a separator with LiNO₃:

The separator (glass fiber filter, glass fiber type A/E, Pall Corporation, thickness 330 μm, diameter 16 mm, porosity 95%) was dried at 80° C. in a drying oven and the weight was determined.

60 μl of the respective aqueous LiNO₃ solution (see table 1) were applied by means of a graduated pipette to the separator and once again dried at 80° C. and the weight was determined. The weight difference indicated the amount of LiNO₃ applied to the separator and was reported in mg of LiNO₃ per cm² of separator area (mg/cm²ₛₑₚₐᵣₐₜₒᵣ) (see table 1).

TABLE 1
Impregnation of the separator with LiNO₃:

| | Concentration of the | Amount of LiNO₃ |
|---|---|---|
| | LiNO₃ solution | on the separator |
| | [mg_{LiNO3}/ml_{H2O}] | [mg/cm²ₛₑₚₐᵣₐₜₒᵣ] |
| Ex. 1a | 1.25 | 0.19 |
| Ex. 1b | 6.25 | 0.37 |
| Ex. 1c | 12.5 | 0.75 |
| Ex. 1d | 25.0 | 1.49 |

### EXAMPLES 2a-d

Lithium Ion Batteries with the Separators from Examples 1a-d:

The electrochemical studies were carried out on a button cell (type CR2032, Hohsen Corp.) in a two-electrode arrangement. An Si-containing electrode coating (70% by weight of silicon, 25% by weight of graphite, 5.0% by weight of polyacrylic acid (binder)) was used as counterelectrode or negative electrode (Dm=15 mm). A coating based on lithium nickel manganese cobalt oxide 6:2:2 having a content of 94.0% and an average weight per unit area of 14.8 mg/cm² (procured from Varta Microbatteries) were used as working electrode or positive electrode (Dm=15 mm). The impregnated glass fiber filters from examples 1a-d served in each case as separator between the electrodes (Dm=16 mm) and were treated with 60 μl of electrolyte. The electrolyte used consisted of a 1.0 molar solution of lithium hexafluorophosphate in a 1:2 (v/v) mixture of ethylene carbonate and diethyl carbonate. Construction of the cell was carried out in a glove box (<1 ppm H₂O, O₂), and the water content in the dry matter of all components used was below 20 ppm.

### EXAMPLES 3a-d

Electrochemical Testing of the Lithium Ion Batteries from Examples 2a-d:

The lithium ion batteries were firstly stored at 45° C. for 20 h. Electrochemical testing was carried out 23° C. Charging of the cell was carried out in the cc/cv (constant current/constant voltage) mode at a constant current of 15 mA/g (corresponds to C/10) in the first cycle and of 75 mA/g (corresponds to C/2) in the subsequent cycles and, after attainment of the voltage limit of 4.2 V, at constant voltage until the current went below 1.5 mA/g (corresponds to C/100) or 19 mA/g (corresponds to C/8). Discharging of the cell was carried out in the cc (constant current) mode at a constant current of 15 mA/g (corresponds to C/10) in the first cycle and of 75 mA/g (corresponds to C/2) in the subsequent cycles until attainment of the voltage limit of 3.0 V. The selected specific current was based on the weight of the coating of the positive electrode.

The test results are summarized in table 5.

### EXAMPLES 4a-b

Impregnation of an Si-containing anode with LiNO₃:

An Si-containing anode (70% by weight of silicon, 25% by weight of graphite, 5.0% by weight of polyacrylic acid (binder)) having an average coating weight per unit area of 3.01 mg/cm² and a diameter of 15 mm was impregnated with 30 μl of an ethanolic LiNO₃ solution (see table 2).

The impregnated anodes were subsequently dried at 80° C. for 2 h in a drying oven and the weight was determined.

The amount of LiNO₃ applied to the anode was calculated from the weight difference and reported in mg of LiNO₃ per cm² of anode area (mg/cm²_{anode}) (see table 2).

TABLE 2
Impregnation of the anode with LiNO₃:

| | Concentration of the | Amount of LiNO₃ |
|---|---|---|
| | LiNO₃ solution | on the anode |
| | [mg_{LiNO3}/ml_{EtOH}] | [mg/cm²_{anode}] |
| Ex. 4a | 21.7 | 0.24 |
| Ex. 4b | 43.3 | 0.58 |

### EXAMPLES 5a-b

Lithium Ion Batteries with the Anodes from Examples 4a-b:

The procedure of examples 2a-d was repeated, with the following differences:

The electrode from examples 4a-b was used as counterelectrode or negative electrode (Dm=15 mm).

A glass fiber filter (Pall Corporation, GF type A/E) impregnated with 60 μl of electrolyte served as separator (Dm=16 mm).

### EXAMPLES 6a-b

Electrochemical Testing of the Lithium Ion Batteries from Examples 5a-b:

The electrochemical testing of the lithium ion batteries from examples 5a-b was carried out in a manner analogous to examples 3a-e.

The test results are summarized in table 5.

### EXAMPLES 7a-b

Impregnation of a Cathode with LiNO₃:

A cathode coating based on lithium nickel manganese cobalt oxide 1:1:1 with 94.0% by weight, an average weight per unit area of 15.1 mg/cm² (procured from Varta Microbatteries) and a diameter of 15 mm was impregnated with 10 μl of the respective ethanolic LiNO₃ solution (see table 3).

The impregnated cathodes were subsequently dried at 80° C. for 2 h in a drying oven and the weight was determined.

The amount of LiNO₃ applied to the cathode was calculated from the weight difference and reported in mg of LiNO₃ per cm² of cathode area (mg/cm²_{cathode}) (see table 3).

TABLE 3
Impregnation of a cathode with LiNO₃:

| | Concentration of the | Amount of LiNO₃ |
|---|---|---|
| | LiNO₃ solution | on the cathode |
| | [mg_{LiNO3}/ml_{EtOH}] | [mg/cm²_{cathode}] |
| Ex. 7a | 65 | 0.36 |
| Ex. 7b | 130 | 0.81 |

### EXAMPLES 8a-b

Lithium Ion Batteries with the Cathodes from Examples 7a-b:

The procedure of examples 2a-d was repeated, with the following differences:

The electrode from examples 7a-b was used as working electrode or positive electrode (Dm=15 mm).

A glass fiber filter (Pall Corporation, GF Type A/E) impregnated with 60 μl of electrolyte served as separator (Dm=16 mm).

### EXAMPLES 9a-b

Electrochemical Testing of the Lithium Ion Batteries from Examples 8a-b:

The electrochemical testing of the lithium ion batteries from examples 8a-b was carried out in a manner analogous to examples 3a-e.

The test results are summarized in table 5.

### EXAMPLE 10

Introduction of LiNO₃ into Anode Ink for Si Anode:

3.500 g of polyacrylic acid (Sigma-Aldrich, Mw ˜450.000 g/mol) which had been dried to constant weight at 85° C. and 65.61 g of deionized water were agitated by means of a roll mixer for 12 hours at room temperature until the polyacrylic acid had completely dissolved. Lithium hydroxide monohydrate (Sigma-Aldrich) was added a little at a time to the solution until the pH was 7.0 (measured using pH meter WTW pH 340i and electrode SenTix RJD). The solution was subsequently mixed for a further 30 minutes by means of the roll mixer. 1.1 g of LiNO₃ (Sigma Aldrich) were dissolved in 3.2 g of deionized water. 12.50 g of the neutralized polyacrylic acid solution and 7.00 g of splinter-shaped silicon particles were then dispersed by means of a high-speed mixer at a circumferential speed of 4.5 m/s for 5 minutes with cooling at 20° C. After addition of 2.50 g of graphite (Imerys, KS6L C), the mixture was stirred for a further 5 minutes at a circumferential speed of 4.5 m/s and 30 minutes at 12 m/s. After degassing in the Speedmixer for 5 minutes, the dispersion was applied by means of a film drawing frame having a gap height of 0.08 mm (Erichsen, model 360) to a copper foil having a thickness of 0.030 mm (Schlenk Metallfolien, SE-Cu58). The anode coating produced in this way was subsequently predried at 50° C. and dried at 80° C. and an atmospheric pressure of 1 bar for 2 hours in a drying oven. The average weight per unit area of the dry anode coating was 3.37 mg/cm² with a nitrate content of 0.34 mg/cm² (10% by weight of LiNO₃ in the solids of the anode coating). The density of the coating was 1.15 g/cm³.

### EXAMPLE 11

Lithium Ion Batteries with the Anode from Example 10:

The procedure of examples 2a-d was repeated, with the following differences:

The electrode coating from example 10 was used as counterelectrode or negative electrode (Dm=15 mm).

A glass fiber filter (Pall Corporation, GF Type A/E) impregnated with 60 μl of electrolyte served as separator (Dm=16 mm).

### EXAMPLE 12

Electrochemical Testing of the Lithium Ion Batteries from Example 11:

The electrochemical testing of the lithium ion batteries from example 11 was carried out in a manner analogous to examples 3a-e.

The test results are summarized in table 5.

### COMPARATIVE EXAMPLES 13a-b

Lithium Ion Battery with Nitrate-Free Anode, Cathode and Separator.

The procedure of examples 2a-d was repeated, with the following differences:

A glass fiber filter (Pall Corporation, GF Type A/E) impregnated with 60 μl of electrolyte served as separator (Dm=16 mm).

The electrolyte used consisted of a 1.0 molar solution of lithium hexafluorophosphate in a 1:2 (v/v) mixture of ethylene carbonate and diethyl carbonate and optionally LiNO₃ (see table 4).

TABLE 4
Addition of LiNO₃ to the electrolyte:

| | LiNO₃ | Amount of LiNO₃^{a)} |
|---|---|---|
| | addition | [% by weight] |
| CEx. 13a | no | 0 |
| CEx. 13b | yes | 0.2 |

^{a)}Figure in % by weight is based on the total weight of the electrolyte.

### COMPARATIVE EXAMPLES 14a-b

Electrochemical Testing of the Lithium Ion Batteries from Comparative Examples 13a-b:

The electrochemical testing of the lithium ion batteries from comparative examples 13a-b was carried out in a manner analogous to examples 3a-e.

The test results are summarized in table 5.

The number of cycles with retention of 80% capacity could be considerably increased by addition of LiNO₃ to anodes, cathodes or the separator: an improvement of up to 333% compared to comparative example 14a without addition of LiNO₃ and an improvement of up to 115% compared to comparative example 14b were achieved using nitrate-containing electrolyte.

The initial reversible capacity (cycle 1) attained a high level here.

TABLE 5
Results of the electrochemical testing of examples 3a-d, 6a-b,
9a-b and 10 and also comparative examples 14a-b:

| | | Discharging capacity | Number of cycles |
|---|---|---|---|
| | LiNO₃ | after cycle 1 | with 80% |
| | reservoir | [mAh/cm²] | capacity retention |
| Ex. 3a | Separator: | 2.13 | 270 |
| | 0.19 mg/cm² | | |
| Ex. 3b | Separator: | 2.14 | 297 |
| | 0.37 mg/cm² | | |
| Ex. 3c | Separator: | 2.18 | 301 |
| | 0.75 mg/cm² | | |
| Ex. 3d | Separator: | 2.11 | 298 |
| | 1.49 mg/cm² | | |
| Ex. 6a | Anode: | 2.13 | 286 |
| | 0.24 mg/cm² | | |
| Ex. 6b | Anode: | 2.10 | 267 |
| | 0.58 mg/cm² | | |
| Ex. 9a | Cathode: | 2.14 | 262 |
| | 0.36 mg/cm² | | |
| Ex. 9b | Cathode: | 2.03 | 305 |
| | 0.81 mg/cm² | | |
| Ex. 12 | Anode: | 2.11 | 224 |
| | 0.34 mg/cm² | | |
| CEx. 14a | — | 2.19 | 90 |
| CEx. 14b | Electrode: | 2.14 | 261 |
| | 0.2% by weight | | |

1-13. (canceled)

14. A lithium ion battery, comprising:
a cathode, an anode, a separator, an electrolyte and a battery housing accommodating the cathode, the anode, the separator and the electrolyte;
wherein the cathode, the anode, the separator or another reservoir which is different from the electrolyte and is present in the battery housing and contains one or more organic or inorganic nitrates or one or more organic or inorganic nitrites; and
wherein the anode contains silicon particles having a silicon content of ≥90% by weight, based on the total weight of the silicon particles.

15. The lithium ion battery of claim 14, wherein the one or more organic nitrates are selected from the group consisting of propyl nitrate, butyl nitrate, isopropyl nitrate and isobutyl nitrate; or
wherein the one or more organic nitrites are selected from the group consisting of methyl nitrite, ethyl nitrite, propyl nitrite, butyl nitrite, isopropyl nitrite, isobutyl nitrite, t-butyl nitrite, benzyl nitrite and phenyl nitrite.

16. The lithium ion battery of claim 14, wherein the one or more inorganic nitrates or the one or more inorganic nitrites are present in the form of their alkali metal salts, alkaline earth metal salts or ammonium salts.

17. The lithium ion battery of claim 14, wherein the one or more inorganic nitrates or the one or more inorganic nitrites are present in the form of their tetrabutylammonium, tetraethylammonium, tetrapropylammonium, sodium, potassium or lithium salts.

18. The lithium ion battery of claim 14, wherein the anode, the cathode or the separator contains from 0.01 to 5.0 mg/cm² of organic or inorganic nitrates or organic or inorganic nitrites, based on the area of the anode, of the cathode or of the separator.

19. The lithium ion battery of claim 14, wherein the anode, the cathode and the separator in total contain from 0.5 to 60% by weight of organic or inorganic nitrates or organic or inorganic nitrites, based on the total dry weight of the anode coating, of the cathode coating and of the separator.

20. The lithium ion battery of claim 14, wherein the one or more organic or inorganic nitrates or the one or more organic or inorganic nitrites are present in the cathode, in the anode or in the separator in an amount of from 0.01 to 10% by weight, based on the weight of the electrolyte.

21. The lithium ion battery of claim 14, wherein the anode, the cathode and/or the separator contain from 0.14 to 73.0 μmol/cm² of organic or inorganic nitrates or organic or inorganic nitrites, in each case based on the area of the anode, of the cathode and/or of the separator.

22. The lithium ion battery of claim 14, wherein the another reservoir which is different from the electrolyte and is present in the battery housing has been applied in the form of a coating to the inside of the battery housing, where the coating contains organic or inorganic nitrates or organic or inorganic nitrites.

23. The lithium ion battery of claim 14, wherein the another reservoir which is different from the electrolyte and is present in the battery housing is a porous support in the form of pads, fibers, textile structures, films or sheets containing organic or inorganic nitrates or organic or inorganic nitrites.

24. The lithium ion battery of claim 14, wherein the anode material in the fully charged lithium ion battery is only partially lithiated.

25. The lithium ion battery of claim 14, wherein the ratio of the lithium atoms to the silicon atoms in the partially lithiated anode material of the fully charged battery is ≤2.2.

26. A process for producing the lithium ion batteries of claim 14, wherein the one or more organic or inorganic nitrates or the one or more organic or inorganic nitrites are introduced into a cathode, into an anode, into a separator or into another reservoir which is different from the electrolyte and is present in the battery housing and silicon particles having a silicon content of ≥90% by weight, based on the total weight of the silicon particles, are used for producing the anode.
